(19) United States
(12) Patent Application Publication
(10) Pub. No.: US 2008/0171665 A1
(43) Pub. Date: Jul. 17, 2008

(54) Programmed changes in hybridization conditions to improve probe signal quality

(76) Inventor: James M. Minor, San Jose, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/440,866

(22) Filed: May 24, 2006

(51) Int. Cl. C40B 40/00; C40B 99/00; G06F 19/00

(52) U.S. Cl. 506/13; 506/43; 702/20

(57) ABSTRACT

A method of improving signal-to-noise performance of a probe. A probe or set of probes is provided for hybridization with a sample. The probe or set of probes is hybridized with the sample at a first hybridization stringency over a first hybridization time period. Following the hybridization over the first hybridization time period, the probe or set of probes is hybridized with the sample at a second hybridization stringency over a second hybridization time period. A method of improving signal-to-noise performance of probes on an array includes providing a sample containing sequences that provide perfect complementary matches to sequences contained on at least some of said probes; and hybridizing the probes with the sample, while cycling the stringency of hybridization conditions during the hybridization.

### CROSS-REFERENCE

This application is related to application Ser. No. (application Ser. No. not yet assigned, Attorney's Docket No. 10051736-1) filed concurrently herewith and titled “Array Design Facilitated by Consideration of Hybridization Kinetics”, which is hereby incorporated herein, in its entirety, by reference thereto.

### BACKGROUND OF THE INVENTION

Arrays of binding agents or probes, such as polypeptide and nucleic acids, have become an increasingly important tool in the biotechnology industry and related fields. These binding agent arrays, in which a plurality of probes are positioned on a solid support surface in the form of an array or pattern, find use in a variety of different fields, e.g., genomics ( in sequencing by hybridization, SNP detection, differential gene expression analysis, CGH analysis, location analysis, identification of novel genes, gene mapping, finger printing, etc.) and proteomics.

In using such arrays, the surface-bound probes are contacted with molecules or analytes of interest, i.e., targets, in a sample. Targets in the sample bind to the complementary probes on the substrate to form a binding complex. The pattern of binding of the targets to the probe features or spots on the substrate produces a pattern on the surface of the substrate and provides desired information about the sample. In most instances, the targets are labeled with a detectable label or reporter such as a fluorescent label, chemiluminescent label or radioactive label. The resultant binding interaction or complexes of binding pairs are then detected and read or interrogated, for example, by optical means, although other methods may also be used depending on the detectable label employed. For example, laser light may be used to excite fluorescent labels bound to a target, generating a signal only in those spots on the substrate that have a target, and thus a fluorescent label, bound to a probe molecule. This pattern may then be digitally scanned for computer analysis.

Generally, in discovering or designing probes to be used in an array, a nucleic acid sequence is selected based on the particular gene or genetic locus of interest, where the nucleic acid sequence may be as great as about 60 or more nucleotides in length, or as small as about 25 nucleotides in length or less. From the nucleic acid sequence, probes are synthesized according to various nucleic acid sequence regions, i.e., subsequences of the nucleic acid sequence and are associated with a substrate to produce a nucleic acid array. As described above, a detectably labeled sample is contacted with the array, where targets in the sample bind to complementary probe sequences of the array.

Gene expression, CGH and location analysis on microarrays are examples of techniques that utilize the property of nucleotides binding to their complements. One problem relating to microarray assays is non-specific binding, where probes on the microarray bind to other sequences than the intended target, in addition to binding to the intended target. This increases both the noise and the bias of the signals read from the probes. Generally, hybridized probes will exhibit non-specific binding to sequences that are not a perfect match to the sequence of the probe, as well as specific binding to sequences that are perfect matches to the probe sequence. To increase the accuracy and specificity of microarray experimental results, it is important to reduce the level of non-specific binding to probes, as non-specific binding generates noise that obscures the signal from the targets that are specifically bonded to the probe and produces bias. There is currently no known method of reducing non-specific binding during the hybridization process.

Accordingly, there is a need for methods of reducing non-specific binding to probes during the hybridization process, to increase probe performance by increasing the signal-to-noise performance of probes.

### SUMMARY OF THE INVENTION

Methods, systems, computer readable media and kits for improving signal-to-noise performance of a probe include: providing a probe for hybridization with a sample; hybridizing the probe with the sample at a first hybridization stringency over a first hybridization time period; and, following the hybridization over the first hybridization time period, hybridizing the probe with the sample at a second hybridization stringency over a second hybridization time period.

Methods, systems, kits and computer readable media are provided for improving signal-to-noise performance of probes on an array. A sample is provided, containing sequences that provide perfect complementary matches to sequences contained on at least some of said probes; and the probes are hybridized with the sample, while cycling the stringency of hybridization conditions during the hybridization.

Arrays processed by the methods described herein are also provided.

Kits for carrying out the methods disclosed herein are also provided.

These and other features of the invention will become apparent to those persons skilled in the art upon reading the details of the methods as more fully described below.

### BRIEF DESCRIPTION OF THE DRAWINGS

FIG. 1 shows an exemplary substrate carrying an array, such as may be feature extracted by a feature extraction system to provide feature extraction output data.

FIG. 2 shows an enlarged view of a portion of FIG. 1 showing spots or features.

FIG. 3 illustrates impact of stringency cycling on signal to noise ratio results for a probe.

FIG. 4 illustrates events that may be carried out to improve signal-to-noise ratio probe performance.

FIG. 5 is a schematic illustration of a typical computer system that may be used to perform procedures described herein.

### DETAILED DESCRIPTION OF THE INVENTION

Before the present methods, systems and computer readable media are described, it is to be understood that this invention is not limited to particular genes, genomes, methods, method steps, statistical methods, hardware or software described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are now described. All publications mentioned herein are incorporated herein by reference to disclose and describe the methods and/or materials in connection with which the publications are cited.

It must be noted that as used herein and in the appended claims, the singular forms “a”, “an”, and “the” include plural referents unless the context clearly dictates otherwise. Thus, for example, reference to “a probe” includes a plurality of such probes and reference to “the sample” includes reference to one or more samples and equivalents thereof known to those skilled in the art, and so forth.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed.

### Definitions

A “nucleotide” refers to a sub-unit of a nucleic acid and has a phosphate group, a 5 carbon sugar and a nitrogen containing base, as well as functional analogs (whether synthetic or naturally occurring) of such sub-units which in the polymer form (as a polynucleotide) can hybridize with naturally occurring polynucleotides in a sequence specific manner analogous to that of two naturally occurring polynucleotides. For example, a “biopolymer” includes DNA (including cDNA), RNA, oligonucleotides, and PNA and other polynucleotides as described in U.S. Pat. No. 5,948,902 and references cited therein (all of which are incorporated herein by reference), regardless of the source.

An “oligonucleotide” generally refers to a nucleotide multimer of about 10 to 100 nucleotides in length, while a “polynucleotide” includes a nucleotide multimer having any number of nucleotides. A “biomonomer” references a single unit, which can be linked with the same or other biomonomers to form a biopolymer (for example, a single amino acid or nucleotide with two linking groups one or both of which may have removable protecting groups).

A nucleotide “Probe” means a nucleotide which hybridizes in a specific manner to a nucleotide target sequence (e.g. a consensus region or an expressed transcript of a gene of interest).

A “chemical array”, “microarray”, “bioarray” or “array”, unless a contrary intention appears, includes any one-, two- or three-dimensional arrangement of addressable regions bearing a particular chemical moiety or moieties associated with that region. A microarray is “addressable” in that it has multiple regions of moieties such that a region at a particular predetermined location on the microarray will detect a particular target or class of targets (although a feature may incidentally detect non-targets of that feature). Array features are typically, but need not be, separated by intervening spaces. In the case of an array, the “target” will be referenced as a moiety in a mobile phase, to be detected by probes, which are bound to the substrate at the various regions. However, either of the “target” or “target probes” may be the one, which is to be evaluated by the other.

Methods to fabricate arrays are described in detail in U.S. Pat. Nos. 6,242,266; 6,232,072; 6,180,351; 6,171,797 and 6,323,043. As already mentioned, these references are incorporated herein by reference. Other drop deposition methods can be used for fabrication, as previously described herein. Also, instead of drop deposition methods, photolithographic array fabrication methods may be used. Interfeature areas need not be present particularly when the arrays are made by photolithographic methods as described in those patents.

Following receipt by a user, an array will typically be exposed to a sample and then read. Reading of an array may be accomplished by illuminating the array and reading the location and intensity of resulting fluorescence at multiple regions on each feature of the array. For example, a scanner may be used for this purpose is the AGILENT MICROARRAY SCANNER manufactured by Agilent Technologies, Palo, Alto, Calif. or other similar scanner. Other suitable apparatus and methods are described in U.S. Pat. Nos. 6,518,556; 6,486,457; 6,406,849; 6,371,370; 6,355,921; 6,320,196; 6,251,685 and 6,222,664. Scanning typically produces a scanned image of the array which may be directly inputted to a feature extraction system for direct processing and/or saved in a computer storage device for subsequent processing. However, arrays may be read by any other methods or apparatus than the foregoing, other reading methods including other optical techniques or electrical techniques (where each feature is provided with an electrode to detect bonding at that feature in a manner disclosed in U.S. Pat. Nos. 6,251,685, 6,221,583 and elsewhere). In any case, detection is made for the purpose of identifying and quantifying of the particular target(s) bonded (i.e., hybridized) to a particular probe.

An array is “addressable” when it has multiple regions of different moieties, i.e., features (e.g., each made up of different oligonucleotide sequences) such that a region (i.e., a “feature” or “spot” of the array) at a particular predetermined location (i.e., an “address”) on the array will detect a particular solution phase nucleic acid sequence. Array features are typically, but need not be, separated by intervening spaces.

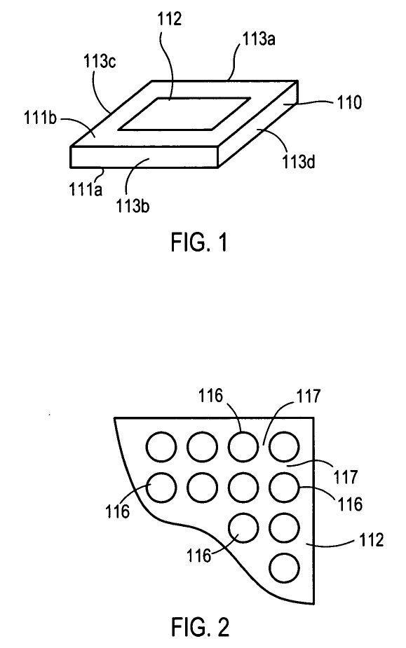

An exemplary array is shown in FIGS. 1-2, where the array shown in this representative embodiment includes a contiguous planar substrate 110 carrying an array 112 disposed on a surface 111b of substrate 110. It will be appreciated though, that more than one array (any of which are the same or different) may be present on surface 111b, with or without spacing between such arrays. That is, any given substrate may carry one, two, four or more arrays disposed on a front surface of the substrate and depending on the use of the array, any or all of the arrays may be the same or different from one another and each may contain multiple spots or features. The one or more arrays 112 usually cover only a portion of the surface 111b, with regions of the surface 111b adjacent the opposed sides 113c, 113d and leading end 113a and trailing end 113b of slide 110, not being covered by any array 112. A surface 111a of the slide 110 typically does not carry any arrays 112. Each array 112 can be designed for testing against any type of sample, whether a trial sample, reference sample, a combination of them, or a known mixture of biopolymers such as polynucleotides. Substrate 110 may be of any shape, as mentioned above.

As mentioned above, array 112 contains multiple spots or features 116 of oligomers, e.g., in the form of polynucleotides, and specifically oligonucleotides. As mentioned above, all of the features 116 may be different, or some or all could be the same. The interfeature areas 117 could be of various sizes and configurations. Each feature carries a predetermined oligomer such as a predetermined polynucleotide (which includes the possibility of mixtures of polynucleotides). It will be understood that there may be a linker molecule (not shown) of any known types between the surface 111b and the first nucleotide.

Substrate 110 may carry on surface 111a, an identification code, e.g., in the form of bar code (not shown) or the like printed on a substrate in the form of a paper or plastic label attached by adhesive or any convenient means. The identification code contains information relating to array 112, where such information may include, but is not limited to, an identification of array 112, i.e., layout information relating to the array(s), etc.

In the case of an array in the context of the present application, the “target” may be referenced as a moiety in a mobile phase (typically fluid), to be detected by “probes” which are bound to the substrate at the various regions.

A “scan region” refers to a contiguous (preferably, rectangular) area in which the array spots or features of interest, as defined above, are found or detected. Where fluorescent labels are employed, the scan region is that portion of the total area illuminated from which the resulting fluorescence is detected and recorded. Where other detection protocols are employed, the scan region is that portion of the total area queried from which resulting signal is detected and recorded. For the purposes of this invention and with respect to fluorescent detection embodiments, the scan region includes the entire area of the slide scanned in each pass of the lens, between the first feature of interest, and the last feature of interest, even if there exist intervening areas that lack features of interest.

An “array layout” refers to one or more characteristics of the features, such as feature positioning on the substrate, one or more feature dimensions, and an indication of a moiety at a given location. “Hybridizing” and “binding”, with respect to nucleic acids, are used interchangeably.

A “design file” is typically provided by an array manufacturer and is a file that embodies all the information that the array designer from the array manufacturer considered to be pertinent to array interpretation. For example, Agilent Technologies supplies its array users with a design file written in the XML language that describes the geometry as well as the biological content of a particular array.

A “grid template” or “design pattern” is a description of relative placement of features, with annotation. A grid template or design pattern can be generated from parsing a design file and can be saved/stored on a computer storage device. A grid template has basic grid information from the design file that it was generated from, which information may include, for example, the number of rows in the array from which the grid template was generated, the number of columns in the array from which the grid template was generated, column spacings, subgrid row and column numbers, if applicable, spacings between subgrids, number of arrays/hybridizations on a slide, etc. An alternative way of creating a grid template is by using an interactive grid mode provided by the system, which also provides the ability to add further information, for example, such as subgrid relative spacings, rotation and skew information, etc.

“Image processing” refers to processing of an electronic image file representing a slide containing at least one array, which is typically, but not necessarily in TIFF format, wherein processing is carried out to find a grid that fits the features of the array, e.g., to find individual spot/feature centroids, spot/feature radii, etc. Image processing may even include processing signals from the located features to determine mean or median signals from each feature and may further include associated statistical processing. At the end of an image processing step, a user has all the information that can be gathered from the image.

“Post processing” or “post processing/data analysis”, sometimes just referred to as “data analysis” refers to processing signals from the located features, obtained from the image processing, to extract more information about each feature. Post processing may include but is not limited to various background level subtraction algorithms, dye normalization processing, finding ratios, and other processes known in the art.

“Feature extraction” may refer to image processing and/or post processing, or just to image processing. An extraction refers to the information gained from image processing and/or post processing a single array.

“Stringency” is a term used in hybridization experiments to denote the degree of homology between the probe and the target hybridized thereto. The higher the stringency, the higher percent homology between the probe and target. Hybridization stringency may be effected by a change in temperature and/or chemical process steps such as the amounts of salts and/or formamide in the hybridization solution during a hybridization process.

“in silico metrics” are those metrics that can be calculated in the absence of any experimental data. They can be derived from the probe sequences of the probes themselves and from the sequences of the genome or the transcriptome of the respective organism. in silico metrics can be used for each candidate probe that are calculated from the sequences directly, using the known laws of physics or chemistry, such as those related to thermodynamics. These metrics include (but are not limited to): duplex melting temperature (Tₘ or Duplex™) between a probe and its complementary sequence; the probes' maximal subsequence duplex melting temperature, which we define as the maximal Tₘ for any subsequence of length M within a longer sequence of length N. (MaxSubSeq™); hairpin thermodynamics of the probe, such as expressed in terms of its hairpin melting temperature, or Gibbs Free energy, number of bases within stems, loops or other structures, . . . ; hairpin thermodynamics of the target molecules, such as hairpin melting temperature, or Gibbs Free energy, etc; and the complexity of a sequence.

Hairpin thermodynamics of the target molecules can be much more difficult to calculate than hairpin thermodynamics of the probe, as the targets are usually much longer than the probes, Also, the boundaries of the targets are only known for targets that are well defined often by restriction digest of the end points. There are many factors the effect the target, such as the methods of labeling often generate labeled targets much shorter than the template, (especially when they are random primed, rather than end-labeled). Also enzymes used for labeling are often inefficient for labeled nucleotides and fall of the template. Additionally, there are many forms of degradation of the targets associated with its storage (e.g. formalin-Fixed paraffin-embedded DNA), or it's purification, amplification or processing). These may include, random shearing or biased shearing of the DNA.

The Complexity of a sequence can take many forms. “Complexity” is defined here as the number of bases (of the probe) that are contained within short simple repeats, such as homopolymers, dimers, trimers (e.g. ACGACGACGACG . . . ), tetramers, . . . . In our current calculation of complexity, we typically consider repeats of as many as 6-nucleotides (hexamers), but there is no reason that one cannot include more.

Another set of in silico metrics relates to the homology of a probe, such as the homology score, HomLogS2B (which is described in detail in application Ser. No. 10/996,323 filed Nov. 23, 2004 and titled “Probe Design Methods and Microarrays for Comparative Hybridization and Location Analysis”, which is hereby incorporated herein, in its entirety, by reference thereto), distance to the nearest hit (not including the first specific target sequence) within the genome (or transcriptome for expression), and other scores that combine homology with the thermodynamic characteristics of the near hits. Another set of in silico metrics relates to measurable quantities that are indicative of probe performance, such as those that can be extracted from “simple” non-differential model systems, such as self-self or the male-female model systems as applied to probe selection for autosomes for CGH applications. These include the various signal measurements for the probes, the dye-biases, the cross-hybridization to targets whose copy numbers are varied in the model system (for CGH applications), differential sensitivity measurements by temperature, salt etc.

Another score related to homology is referred to as the “predicted homology response”, denoted by Sₕₒₘ. This score is similar to HomLogS2B, but instead of predicting the Signal-to-background, this score predicts the slope response of a probe based on Homology calculations alone under the assumption that the thermodynamic and other properties of the probe are ideal. This predicted homology slope can be defined as:

$${S}_{Hom} ≡ \frac{{\sum }_{j = 1}^{TargetSeq .} P ( m {m}_{j} )}{{\sum }_{i = 1}^{Genome} P ( m {m}_{i} )} \qquad ( 1 )$$

where P(mmⱼ) is a penalty term representing the signal contribution (under the specified hybridization conditions) for the hybridization of the probe of interest to each sufficiently complementary mismatch sequence within a specified target sequence, set of target sequences, or genome. The summation in the denominator is over all the sequences in the genome, or within the complex set of sequences expected to be in a sample or set of samples. The numerator represents the target sequence of interest. In the most specific case, the target sequence refers to the small specific sequence for which the probe was designed within a particular locus within a narrow region of the specific chromosome for which it was designed. In this case, the expression above can be simplified to

$${S}_{Hom} = \frac{1}{{\sum }_{i = 1}^{Genome} P ( m {m}_{i} )} \qquad ( 2 )$$

The function P(mmⱼ) can be calculated using a model for the hybridization between oligo sequences for using nearest neighbor models. This term is dependent on the number of mismatches, the distributions of mismatches through the aligned sequences, the specific mismatched bases, and the length of the overlap. In principle all possible sequences within the target sequences (or whole genome) should be considered, but in practice, only those sequences that are close (homologous enough) to the probe sequence need be considered. In the case of 60-mers probes, considering all subsequences in the genome that align with fewer than about 20 bases appears to be a sufficient approximation, yet one that still takes considerable computational resources to calculate.

In a further simplified model where we find the distances (or numbers of mismatches) between the probe and the nearest hits in the genome, the homology slope response can be approximated as

$${S}_{Hom} \approx \frac{{\sum }_{d = 0}^{D} {P}_{d} {M}_{d}}{{\sum }_{d = 0}^{D} {P}_{d} {N}_{d}} \qquad ( 3 )$$

where N_{d} represents the total number of hits at a distance d, where d is defined as the number of single-base differences between the probe of interest and the complex set of sequences, or the whole genome, and D is the maximum distance that needs to be considered. The denominator again represents the signal contributions of all probes in the complex set of sequences (including the target sequence). In Equation (3), the numerator represents either the target for the probe sequence itself, or in the case of a model system, it may represent the region of the model system's sequence that is being varied. For example, if the model system for a whole chromosome M_{d} represents the number of all hits within that chromosome at a distance d from the probe of interest, then P_{d} is the signal penalty for each target mismatch at a distance d. In this case a perfect match has P_{d}=1, and the value of P_{d} decreases as the number of mismatches increases, and as they become more destabilizing. This is an approximation because the precise penalty should be related to the exact sequences of both the target and probe sequence and related to the distributions of those mismatches, insertions and deletions. Again, the use of a nearest neighbor model within the homology search calculator can improve the accuracy of this approximation. The approximation is based on the assumption that the average signal reduction across a large number of probe-target mismatches is a good representation for any given mismatch of the same order. In the simplest approximation we can take assign a constant penalty P for each mismatched base, or base-insertion or base-deletion. In this case, we can relate a overall single-base penalty to the distance by

P_{d}≈^{d} (4)

Still there are other homology scores, such as, maxTemp, that combine homology with the thermodynamic characteristics of the near hits. In this case, maxTemp is defined as the duplex melting temperature between the probe and the longest contiguous match within each homologous sequence in the background genome. The duplex melting temperature may be calculated by the simple formula where each matching GC-pair gets a value of two, and each matching A-T pair gets a value of 1, and the sum of these roughly approximates the melting temperature. Although this is an overly simple calculation of the melting temperature, it is used for the purpose of speed since the calculation needs to be done of all near hits in the genome.

MMClosestDuplex™ is the melting temperature of the closest mismatch to the probe sequence in the genome as calculated using a nearest neighbor model.

Model systems for CGH applications may be used that include regions of known copy number changes to establish the relationships between calculable or measurable metrics and the probe performance that can be measured in these systems. This can be accomplished by tuning parameters that characterize the performance for each of the metrics.

The X-chromosome provides a useful model system for doing this performance characterization. However, like many of the possible model systems, the X-chromosome is less than idyllic in that each probe within it does not necessarily exist at a single locus within the variable region. Additionally, there may be a number of other homologous regions within the region systematically varied by the model system that do not exactly match the intended target of the probe sequence. This is especially true for models with large contiguous regions, such as the X-chromosome or other cell lines with aberrations in a chromosome or a segment of a chromosome.

Currently the methods for calculating the homology scores, do not discriminate between probes that have multiple exact copies within the variable region (the X-chromosome) and those that have multiple copies elsewhere in the genome. For this reason, these metrics may be modified by removing the X-chromosome from the background genome set and replacing it with a string of bases consisting of the concatenated set of X-chromosome probes that are being evaluated.

When one item is indicated as being “remote” from another, this is referenced that the two items are not at the same physical location, e.g., the items are at least in different buildings, and may be at least one mile, ten miles, or at least one hundred miles apart.

“Communicating” information references transmitting the data representing that information as electrical signals over a suitable communication channel (for example, a private or public network).

“Forwarding” an item refers to any means of getting that item from one location to the next, whether by physically transporting that item or otherwise (where that is possible) and includes, at least in the case of data, physically transporting a medium carrying the data or communicating the data.

A “processor” references any hardware and/or software combination which will perform the functions required of it. For example, any processor herein may be a programmable digital microprocessor such as available in the form of a mainframe, server, or personal computer. Where the processor is programmable, suitable programming can be communicated from a remote location to the processor, or previously saved in a computer program product. For example, a magnetic or optical disk may carry the programming, and can be read by a suitable disk reader communicating with each processor at its corresponding station.

Reference to a singular item, includes the possibility that there are plural of the same items present.

“May” means optionally.

Methods recited herein may be carried out in any order of the recited events which is logically possible, as well as the recited order of events.

All patents and other references cited in this application, are incorporated into this application by reference except insofar as they may conflict with those of the present application (in which case the present application prevails).

### Methods, Systems and Computer Readable Media

The methods of the present invention described herein may be carried out to reduce non-specific binding of probes and thereby improve signal-to-noise characteristics of signals read from these probes for their intended targets.

Probes processed according to the present techniques exhibit a relatively higher ratio of signal from binding with an intended target to signal from non-specific binding (i.e., signal from cross-hybridization, i.e., noise) compared to the same probes processed under currently existing techniques. The present invention provides methods for improving probe properties during the hybridization process, by applying stringency variations designed to reduce the impact of non-specific binding of probes.

For two identical sets of probes where one set is hybridized to a sample at a first hybridization stringency and the second set is hybridized to the identical sample at a second hybridization stringency higher than the first hybridization stringency (and where both the hybridization stringencies are within a practically effective range), the probes hybridized at the lower hybridization stringency will generally exhibit higher signals when scanned than the probes hybridized at the higher hybridization stringency. Hybridization time is typically set so that adequate signal (i.e., sufficient bonding of target to each probe) is achieved by all probes. However, the signal loss from specific probes (i.e., those that exhibit relatively low cross-hybridization (non-specific binding)) of the higher hybridization stringency set exhibit significantly less signal loss relative to the same probes in the lower hybridization stringency set than the signal loss exhibited by non-specific probes (i.e., those probes that exhibit relatively high amounts of cross-hybridization (non-specific binding)). That is, the stringency-sensitivity of the intensity of signals received from non-specific binding to probes is higher than the stringency-sensitivity to hybridization of the intensity of signals received from specific binding to probes.

Assuming that effects on hybridization such as diffusion are minor (e.g., hybridization protocol times may be in the neighborhood of about 12 to 40 hours to ensure adequate diffusion to all probes, although use of a microwave heat source that applies traveling microwave waves to an array may provide more uniform radiative heat to more accurately and efficiently deliver heat energy, create convective circulation, and thereby decrease the hybridization time required), the population of bound sequence fragments from a target solution applied to a probe can be described by (e.g., see Dai et al., “Use of hybridization kinetics for differentiating specific from non-specific binding to oligonucleotide microarrays”, Nucleic Acids Research, 2002, Vol. 30 No. 16, 2002 Oxford University Press, which is hereby incorporated herein, in its entirety, by reference thereto):

$$\begin{matrix}I ( t , T ) = \frac{OL}{K + \frac{O}{{N}_{O} V} ( 1 - {e}^{- t / τ} )} & ( 5 ) \\ K = {e}^{Δ G / RT} & ( 6 ) \\ τ = {{k}_{f}^{- 1} ( K + \frac{O}{{N}_{O} V} )}^{- 1} & ( 7 )\end{matrix}$$

where:
I=the population or number of bound sequences on a probe from the biological sample. The signal extracted from a probe is monotonically proportional with I;
t=time, in seconds;
T=absolute temperature, in Kelvin;
O=the number of sequence fragments (e.g., nucleotide sequences; oligomers) bound to the probe;
L=the target concentration in moles/liter of the target solution;
K=the kinetic equilibrium disassociation constant, in moles/liter;
Nₒ=Avogadro's number;
V=the volume of hybridization solution, in liters;
τ=a characteristic time over which equilibrium of the hybridization is achieved;
k_{f}=a kinetic parameter as defined in Dai et al, cited above, which denotes the forward time rate of the hybridization process; and
ΔG=the free-energy difference, in kilocalories, fro probe binding at 37C. ΔG changes modestly over the practical ranges of application and therefore is considered as a constant of T, e.g., see SantaLucia, Jr., “A unified view of polymer, dumbbell, and oligonucleotide DNA nearest-neighbor thermodynamics”, Proc. Natl. Acad. Sci. USA, Vol 95, pp. 1460-1465, February 1998, Biochemistry, which is hereby incorporated herein, in its entirety, by reference thereto.

The rate of change of I with respect to T is described by:

$$\begin{matrix}\begin{matrix}r ( t , T ) = \frac{\partial I}{\partial T} \\ = - [ \frac{OL}{{( K + \frac{O}{{N}_{O} V} )}^{2}} ( 1 - {e}^{- t / τ} ) - \frac{OL}{K + \frac{O}{{N}_{O} V}} {e}^{- t / τ} {tk}_{f} ] \frac{\partial K}{\partial T}\end{matrix} & ( 8 ) \\ where \frac{\partial K}{\partial T} = - \frac{Δ G}{{RT}^{2}} {e}^{Δ G / RT} & ( 9 )\end{matrix}$$

As noted, ΔG is considered as a constant of T. For example K is typically ˜10⁻¹⁰ for ˜25-mer oligomers having ΔG of about −14 kcal at 37C. Oligomers having 60-mers create a much greater drop in G, e.g., see Zhang et al., “Competitive Hybridization Kinetics Reveals Unexpected Behavior Patterns”, Biophys J BioFAST, Aug. 26, 2005, doi:10.1529/biophysj.104.058,552, which is hereby incorporated herein, in its entirety, by reference thereto. Also, typically O/N₀V is around 10⁻⁶ moles /liter.

$$Therefore , K ≪ \frac{O}{{N}_{0} V} , and K + \frac{O}{{N}_{0} V} is essentially \frac{O}{{N}_{0} V} .$$

At equilibrium (i.e., t≧τ) the rate equation (i.e., equation (4)) becomes:

$$r ( ∞ , T ) = [ \frac{OL}{{( K + \frac{O}{{N}_{O} V} )}^{2}} ] \frac{Δ G}{{RT}^{ 2}} {e}^{Δ G / RT} \qquad ( 10 )$$

Considering an example for 60-mer probes, a typical “noise sequence” (i.e., a sequence for which a probe has not been designed to specifically bind with, and thus will only bind to probes by non-specific binding (i.e., cross-hybridization)) in a target solution may have a ΔG. (which we designate as ΔGₙ here) of ˜−30 kcal and having a stringency rate designated here by rₙ. A typical “specific sequence” (i.e., a sequence for which a probe exists that this sequence will specifically bind to, i.e., the probe has a complementary sequence to the specific sequence) may have a ΔG (which we designate as ΔGₛ here) of ˜−80 kcal and a stringency rate designated here by rₛ. Given these exemplary ΔG values, a relative stringency rate, rₙ/rₛ at equilibrium can be defined as follows:

$$\frac{{r}_{n} ( ∞ , T )}{{r}_{s} ( ∞ , T )} = \frac{Δ {G}_{n} {e}^{Δ {G}_{n} / RT}}{Δ {G}_{s} {e}^{Δ {G}_{s} / RT}} \geq {e}^{50} \qquad ( 11 )$$

Hence, a decrease in the population of noise sequences on a probe will be much greater than a decrease in the population of the specific sequence for that probe as the hybridization temperature is increased during hybridization processing. This relationship is also true for the non-equilibrium kinetics, e.g., over the course of the hybridization process before it reaches equilibrium. That is, the stringency rate for specific sequences is much greater than that for noise sequences for all time t>0.

Considering a probe that is designed to specifically bind with a sequence on the X chromosome, assume that a sample containing X and Y chromosomes produces a true signal “c” and the signal observed on the probe is “δ+c” where δ=noise and δ>0. Then:

$$\begin{matrix}\frac{δ m + 2 c}{δ + c} = r & ( 12 ) \\ \frac{\frac{δ}{c} m + 2}{\frac{δ}{c} + 1} = r & ( 13 ) \\ \frac{δ}{c} m + 2 = \frac{δ}{c} r + r & ( 14 ) \\ \frac{δ}{c} = \frac{2 - r}{r - m} \leq 0 & ( 15 )\end{matrix}$$

Note that “r” is the observed ratio (i.e., ratio of signal from one channel to signal from second channel; e.g., red signal (Cy5)/green signal (Cy3) and “m” converts XY noise “δ” to an equivalent noise for an XX sample (chromosome XX environment) relative to the chromosome XY environment. This conversion is necessary because the gene noise environment created by female samples (XX) is different from that created by male samples (XY) since the gene sets are different. Hence, r>2 implies m<r. Typically, m is observed to be around 1. If r is 1.5, then typically about half of the observed XY signal is noise. The above derivation shows that a decrease in signal intensity, observed when comparing a probe hybridized at a relatively low temperature with the same probe hybridized at a relatively high temperature will be much greater for a probe designed to specifically bind with a sequence on chromosome X and that has poor ratio performance (e.g., the measured signal ratio is significantly different than the expected signal ratio). Since in general noise tends to be proportional to true signal (where true signal is the signal indicative of specific binding), one can apply an adequate normalization to this change in the log transform of signal intensity across all probes considered for selection for use in an array design by converting to a relative decrease (i.e., divide the signal decrease by signal intensity) or by using a logarithm (e.g., natural logarithm) of the intensity signals for these calculations. The logarithmic method additionally inherently provides better statistical weighting of the normalized signal intensity values.

In addition or alternative to hybridization temperatures, chemical process steps can also impact the stringency rates of specific and noise sequences. For example, that additions of salts and/or formamide to the hybridization solution may alter the stringency rates. In general, the stringency rate of a specific sequence relative to the stringency rate of non-specific (noise) sequences will exhibit a major difference, as described above, regardless of the source(s) driving the stringency for each probe.

Since, in general, noise signals (e.g., signals from non-specific bindings) tend to be proportional to true signal (i.e., signal from specific binding to a probe), an appropriate normalization of intensity signals for calculation of relative stringency rates should be calculated by either converting to a relative decrease (i.e., divide the signal decrease between the same probe at the two different hybridization stringencies by the signal intensity from the probe processed at the higher hybridization stringency), or by calculation the log of the intensity signals for stringency rate calculations, e.g., delta=LogI_{T=60}−LogI_{T=70}. The logarithmic transform (Log transform) inherently provides correct statistical weighting for intensity.

The equations above imply that designed stringency variations (i.e., stringency cycling, e.g., temperature cycling or other cycling of parameters that effect stringency) during the hybridization process can significantly improve the final signal to noise ratio for a probe. Further, specific binding of probes is much slower to reach equilibrium during hybridization then the time it takes for non-specific binding to equilibrate.

In view of the above, hybridization stringency cycling during the hybridization process can significantly improve the final signal-to-noise ratio performance of a probe. By hybridizing a probe at a lower stringency for an amount of time to reach equilibrium, or at least for a time sufficient so that adequate signal (i.e., sufficient binding of specific target to the probe) is achieved by the probe, and then hybridizing at a higher stringency for a shorter cycle time, so that non-specific bindings are significantly impacted, but the slower reacting specific bindings are less impacted, a higher ratio of specific binding to non-specific binding can be achieved after the high stringency cycle, relative to what was achieved in the low stringency cycle. This induced annealing process improves signal with each cycle (i.e., signal ratio of specific binding to non-specific binding, i.e., signal to noise ratio) and repeated cycling in this manner can further improve the resulting signal to noise ratio. Cycle frequency is set according to the response time of the method of changing the stringency (e.g., heating method and/or change in hybridization medium composition), and the number of cycles to be processed can be determined by the cycle frequency and the total length of time over which hybridization processing is to occur. While stringency cycling as described herein mildly inhibits specific binding of intended targets to probes (and thus mildly inhibits the true signal obtained from the probes), it inhibits non-specific binding much more significantly, thereby damping noise build-up during the hybridization process.

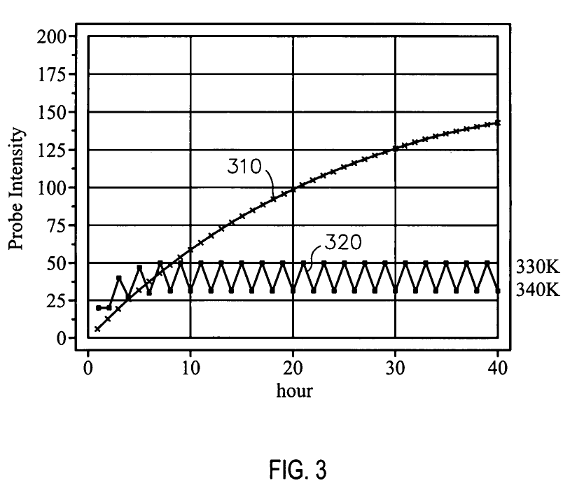

FIG. 3 shows an example of an impact of stringency cycling on signal to noise ratio results for a typical probe measuring a significantly abundant genomic sequence above noise levels. Chart 300 shows plots of signal intensity (Y-axis) versus time (in hours, X-axis)for both specific binding and non-specific binding to a probe, over a hybridization time period of forty hours. A complete cycle (i.e., hybridization processing at the lower stringency conditions and hybridization processing at the higher stringency conditions) is performed every two hours (cycle frequency), with the last hour of the processing (i.e., last high stringency processing portion of the last cycle) being performed at the higher stringency conditions (in this example, higher hybridization temperature of 340 Kelvin or higher) as a “thermal wash” step prior to quenching the hybridization process according to known quenching techniques. This thermal wash treatment prevents cooling down of the probes prior to quenching, and thereby prevents substantial cross-hybridization from re-occurring on the finally hybridized probe(s). In this case, stringency cycling is effected by a change in hybridization temperature, wherein the low hybridization temperature is 330 Kelvin (i.e., 56.85° C.) and the high hybridization temperature is 340 Kelvin (i.e., 66.85° C.). Thus, stringency cycling in this example is performed for 39 hours and then the probes are thermal washed one hour at 340K or higher, and then quenched.

Plot 310 shows the signal intensity values for specific binding to the probe(s) when cycled between the low and high stringencies described. The slight sinusoidal variation in the plot that can be observed on close examination is the result of the stringency cycling. Plot 320 shows signal intensity values for non-specific binding to the probe(s) when cycled between the high and low stringency conditions described. Upon comparing plots 310 and 320 it is readily observable that the low-affinity signals (i.e., resulting from cross-hybridization or noise, signal 320) oscillate to a much greater extent than the oscillation apparent in the high-affinity signal (i.e., specific binding, signal 310), confirming that the non-specific binding responds much more quickly to a change in hybridization conditions than does the specific binding.

When viewing plots 310 and 320, it can be observed that equilibrium time for specific binding (plot 310) is much greater than that for non-specific binding (plot 320), as the plot for specific binding 310 is just beginning to reach steady state at the end of the forty hour period, while plot 320 reaches steady state at about seven to eight hours. Also, it can be observed that the non-specific signal intensity (plot 320) at hybridization temperature of 340K is significantly lower than the non-specific signal intensity at hybridization temperature of 330K, even towards the end of the forty hour hybridization period. These plots demonstrate that stringency cycling in this case improves the signal-to-noise ratio of the probe from about 3:1 (when hybridized at 340K) to about 4:1 when stringency cycling is applied in the manner described. Another explanation for the beneficial results of annealing (stringency cycling) is that during hybridization some target gets bound to the wrong probe(s), i.e., cross-hybridization, or bound on defective strings(sequences). The targets that are cross-hybridized are thus weakly bound, like other noise sequences and other material that produces noise. Each cycle wherein the stringency conditions are made more stringent disengages these weakly bound materials, which enables cross-hybridized targets the opportunity to specifically bind to the probes that were designed for them.

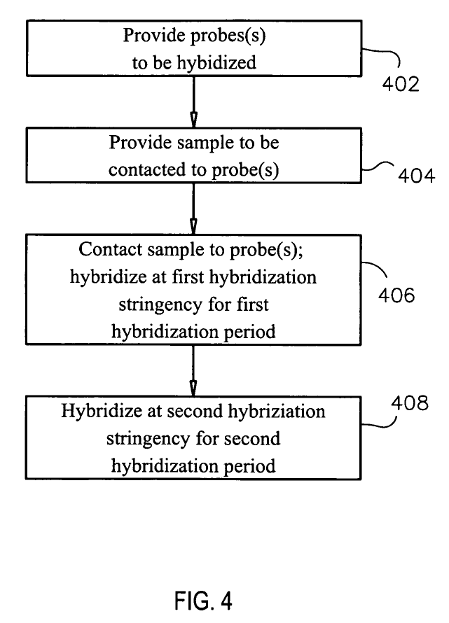

FIG. 4 illustrates events that may be carried out to improve signal-to-noise ratio probe performance. At event 402 a probe or set of probes to be hybridized is provided, typically on an array. The probe or set of probes to be hybridized may be selected according to any existing technique for probe selection or by any of the techniques described in U.S. patent application Ser. No. (Ser. No. not yet assigned, Attorney's Docket No. 10051736-1), or even randomly, as long a specific target exists in the sample to be hybridized to at least one of the probe or set of probes.

At event 404, a sample is provided that is to be contacted to the probe or set of probes to hybridize sequences in the sample to the probe or set of probes. Typically, a set of probes will be provided to contain probes that are designed to specifically bind to specific sequences in the sample.

At event 406, the sample is next contacted to the probe or set of probes and hybridization processing begins. Hybridization is begun by hybridizing at a first hybridization stringency for a first hybridization period. This first hybridization period may be preset, and is typically long enough for specific binding of probes to reach equilibrium or at least sufficient for specific binding of probes to the extent that adequate signal (i.e., sufficient binding of specific target to the probe) is achieved by the probe(s). For example, this first hybridization period may be from about seventeen to about thirty-eight hours, although this time may very depending upon the characteristics of the sample and probes to be bound.

After the first hybridization period is elapsed, the stringency conditions are changed, and the probe or set of probes are hybridized at a second hybridization stringency that is higher than the first hybridization stringency, for a second hybridization period that is less than the first hybridization period. As noted above, and shown in FIG. 3, the reaction time and thus time to reach equilibrium of non-specific bindings is much faster/shorter than that for specific bindings. Accordingly, by hybridizing at the second, higher stringency, for a relatively shorter period of time, the effects of this second stringency will be made much more on non-specific bindings than on specific bindings. Thus, non-specific bindings are removed to a greater extent than specific bindings by hybridizing at the higher stringency. For example, the second hybridization period (for first hybridization times as noted above) may be on the order of about two to three hours.

After the completion of event 408, the probe or set of probes may be washed according to existing wash techniques to remove unbound sequences from the probes. At this time, the probe or set of probes can be processed according to existing protocols, where upon scanning and feature extracting, the signal-to-noise performance of this probe or set of probes will be significantly superior to a like probe or set of probes having been hybridized at solely either the first hybridization stringency or the second hybridization stringency. For example, an improved signal-to-noise ratio of such a probe or set of probes, relative to a like probe or set of probes having been hybridized at solely either the first hybridization stringency or the second hybridization stringency, may be observed to be at least 5% greater, at least 10% greater, at least 25% greater, at least 33% greater or at least 50% greater.

Alternative to the processed described in FIG. 4, hybridization processing may include more than one cycle of processing at a first hybridization stringency and processing at a second hybridization stringency. For example, two or more cycles may be included where each cycle includes processing for a first predetermined time at the first hybridization stringency, and then processing for a second predetermined time at a second hybridization stringency that is higher than the first hybridization stringency. Further optionally, a thermal wash may be performed after the last cycle has been completed, or during the second hybridization stringency period of the last cycle by subjecting the probes to as high or a higher stringency than even the second hybridization stringency, prior to quenching the probes to end the hybridization process. One example of performing this high stringency wash is by performing a thermal wash, where the hybridization temperature is raises as high or higher than the temperature for the second hybridization stringency and is applied for a predetermined period of time, after which-quenching is performed. In general, a high stringency wash may be performed over a predetermined time period at the end of the hybridization processing, wherein the stringency is about the same or greater than the second hybridization stringency. Further optionally, the time periods over which first hybridization stringency is applied and over which second hybridization stringency is applied may be varied for different cycles. Still further optionally, the stringency conditions of one or both of the first hybridization stringency and the second hybridization stringency may be altered between cycles. For example, in a one cycle, the second hybridization stringency may have a hybridization temperature of 69° C. and in the next cycle, the second hybridization stringency may have a hybridization temperature of 70° C. However, the second hybridization stringency maintains its status as having higher stringency than the first hybridization stringency in that cycle.

In general, a high stringency wash, such as a thermal wash may be optimized in conjunction with the chemical wash steps (cleanup) that are typically performed after hybridization processing, that typically follow the hybridization quench. Such optimization may include elimination of some or all chemical wash steps. Chemical wash steps tend to sometimes negatively impact the final hybridization results. For example, residual, anomalous high outlier pixel signals within a probe may be caused by one or more of the typical wash steps that are typically employed, see U.S. Patent Publication No. 2005/0078860, which is hereby incorporated herein, in its entirety, by reference thereto.

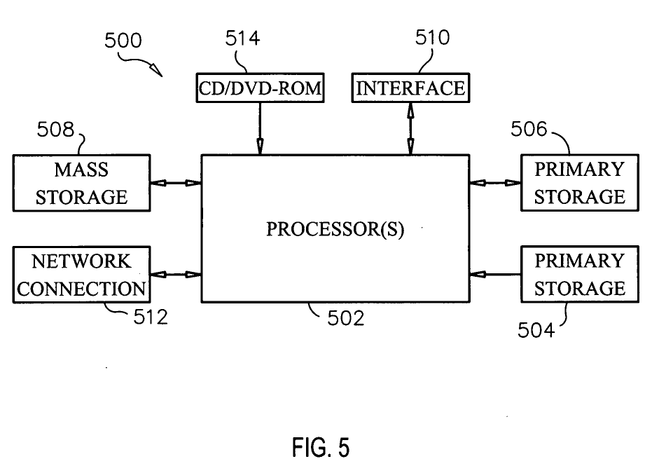

FIG. 5 is a schematic illustration of a typical computer system that may be used to perform procedures described above. The computer system 500 includes any number of processors 502 (also referred to as central processing units, or CPUs) that are coupled to storage devices including primary storage 506 (typically a random access memory, or RAM), primary storage 504 (typically a read only memory, or ROM). As is well known in the art, primary storage 504 acts to transfer data and instructions uni-directionally to the CPU and primary storage 506 is used typically to transfer data and instructions in a bi-directional manner Both of these primary storage devices may include any suitable computer-readable media such as those described above. A mass storage device 508 is also coupled bi-directionally to CPU 502 and provides additional data storage capacity and may include any of the computer-readable media described above. Mass storage device 508 may be used to store programs, data and the like and is typically a secondary storage medium such as a hard disk that is slower than primary storage. It will be appreciated that the information retained within the mass storage device 508, may, in appropriate cases, be incorporated in standard fashion as part of primary storage 506 as virtual memory. A specific mass storage device such as a CD-ROM or DVD-ROM 514 may also pass data uni-directionally to the CPU.

CPU 502 is also coupled to an interface 510 that includes one or more input/output devices such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 502 optionally may be coupled to a computer or telecommunications network using a network connection as shown generally at 512. With such a network connection, it is contemplated that the CPU might receive information from the network, or might output information to the network in the course of performing the above-described method steps. The above-described devices and materials will be familiar to those of skill in the computer hardware and software arts.

The hardware elements described above may implement the instructions of multiple software modules for performing the operations of this invention. For example, instructions for controlling temperature and/or other stringency conditions and monitoring hybridization times may be provided for execution by such hardware. As another example instructions may be provided to one or more CPU's 502 to perform feature extraction from an electronic image of an array having been scanned. Further, instructions may be included for operating a scanner connected to computer system 500 to scan an array and output an electronic image of the scanned array. Outputs of these processes may be displayed on a user interface 510, such as a monitor and/or outputted in hard copy form such as via a printer and/or transmitted, such as by email, fax or other electronic means. Instructions for these processes may be stored on mass storage device 508 or 514, or another storage device accessible to system 500 via network connection 512, and executed on CPU 508 in conjunction with primary memory 506.

In addition, embodiments of the present invention further relate to computer readable media or computer program products that include program instructions and/or data (including data structures) for performing various computer-implemented operations. The media and program instructions may be those specially designed and constructed for the purposes of the present invention, or they may be of the kind well known and available to those having skill in the computer software arts. Examples of computer-readable media include, but are not limited to, magnetic media such as hard disks, floppy disks, and magnetic tape; optical media such as CD-ROM, CDRW, DVD-ROM, or DVD-RW disks; magneto-optical media such as floptical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter.

That which is claimed is:

1. A method of improving signal-to-noise performance of a probe, said method comprising:
providing a probe for hybridization with a sample;
hybridizing the probe with the sample at a first hybridization stringency over a first hybridization time period;
following said hybridizing over the first hybridization time period, hybridizing the probe with the sample at a second hybridization stringency over a second hybridization time period.

2. The method of claim 1, wherein the signal-to-noise performance improves by at least 5%.

3. The method of claim 1, wherein the first and second hybridization stringencies differ by hybridization temperature.

4. The method of claim 1, wherein the first hybridization time period is greater than the second hybridization time period.

5. The method of claim 1, wherein the second hybridization stringency is higher than the first hybridization stringency.

6. The method of claim 1, wherein the first hybridization time period is long enough for specific binding of the probe to reach equilibrium or at least sufficient for specific binding of the probe to produce an adequate signal, and the second hybridization time period is not sufficiently long for sufficient specific binding to produce an adequate signal.

7. The method of claim 1, wherein the first hybridization time period is about seventeen to thirty-eight hours and the second hybridization time period is about tow to three hours.

8. The method of claim 3 wherein the first hybridization stringency comprises a hybridization temperature of about 55 to 60° C. and the second hybridization stringency comprises a hybridization temperature of about 65 to 70° C.

9. The method of claim 1, further comprising repeating the steps of hybridizing the probe with the sample at a first hybridization stringency over a first hybridization time period, and hybridizing the probe with the sample at a second hybridization stringency over a second hybridization time period at least once.

10. The method of claim 1, further comprising quenching the probe at the end of hybridization processing.

11. The method of claim 1, further comprising performing a high stringency wash, for a predetermined wash time under hybridization stringency conditions at least as stringent as said second hybridization stringency.

12. The method of claim 10, wherein said high stringency wash comprises a thermal wash.

13. The method of claim 1, wherein the steps of hybridizing the probe with the sample at a first hybridization stringency over a first hybridization time period, and hybridizing the probe with the sample at a second hybridization stringency over a second hybridization time period comprise a hybridization cycle, said method further comprising performing at least two hybridization cycles.

14. The method of claim 12, comprising changing at least one of the first hybridization time period and the second hybridization time period between consecutive cycles performed.

15. The method of claim 13, comprising changing at least one of the first hybridization stringency and the second hybridization stringency applied by consecutive cycles, but wherein the second hybridization stringency is higher than the first hybridization stringency within each cycle.

16. A method of improving signal-to-noise performance of probes on an array, said method comprising:
providing a sample containing sequences that provide perfect complementary matches to sequences contained on at least some of said probes; and
hybridizing the probes with the sample, while cycling the stringency of hybridization conditions during said hybridizing.

17. The method of claim 16, wherein said cycling comprises:
hybridizing the probes at a first hybridization stringency over a first hybridization time period; and
following said hybridizing over the first hybridization time period, hybridizing the probes at a second hybridization stringency over a second hybridization time period.

18. The method of claim 17, wherein the first and second hybridization stringencies differ by hybridization temperature.

19. The method of claim 17, wherein the first hybridization time period is greater than the second hybridization time period.

20. The method of claim 17, wherein the second hybridization stringency is higher than the first hybridization stringency.

21. The method of claim 17, wherein the first hybridization time period is long enough for specific binding of the probe to reach equilibrium or at least sufficient for specific binding of the probe to produce an adequate signal, and the second hybridization time period is not sufficiently long for sufficient specific binding to produce an adequate signal.

22. The method of claim 17, further comprising quenching the probes at the end of said cycling.

23. The method of claim 17, further comprising performing a high stringency wash at the end of said cycling, for a predetermined wash time under hybridization stringency conditions at least as stringent as said second hybridization stringency.

24. The method of claim 23, wherein said high stringency wash comprises a thermal wash.

25. A computer readable medium carrying one or more sequences of instructions for improving signal-to-noise performance of a probe, wherein a probe is provided for hybridization with a sample, and wherein execution of one or more sequences of instructions by one or more processors causes the one or more processors to perform the steps of:
hybridizing the probe with the sample at a first hybridization stringency over a first hybridization time period; and
following said hybridizing over the first hybridization time period, hybridizing the probe with the sample at a second hybridization stringency over a second hybridization time period.

26. The computer readable medium of claim 25, wherein the following further steps are performed: repeating the steps of hybridizing the probe with the sample at a first hybridization stringency over a first hybridization time period, and hybridizing the probe with the sample at a second hybridization stringency over a second hybridization time period at least once.

27. The computer readable medium of claim 25, wherein the following further step is performed: quenching the probe at the end of hybridization processing.

28. The computer readable medium of claim 25, wherein the following further step is performed: performing a high stringency wash, for a predetermined wash time under hybridization stringency conditions at least as stringent as said second hybridization stringency.

29. A computer readable medium carrying one or more sequences of instructions for improving signal-to-noise performance of probes on an array, wherein probes are provided on an array for hybridization with a sample, wherein the sample contains sequences that provide perfect complementary matches to sequences contained on at least some of said probes, and wherein execution of one or more sequences of instructions by one or more processors causes the one or more processors to perform the steps of:
hybridizing the probes with the sample; and
cycling the stringency of hybridization conditions during said hybridizing.

30. A chemical array comprising probes having been processed by the method of claim 16.

31. A kit for improving signal-to-noise performance of probes on a chemical array array, said kit comprising:
a chemical array provided with a plurality of probes; and
instructions for carrying out the method of claim 16.
